(19) United States
(12) Patent Application Publication
(10) Pub. No.: US 2018/0165714 A1
(43) Pub. Date: Jun. 14, 2018

(54) RADIO FREQUENCY EVENT RESPONSE MARKETING SYSTEM

(71) Applicant: CELERITAS GROUP, LLC, Broomfield, CO (US)

(72) Inventor: Frederick BLECKMANN, Barrington, NH (US)

(73) Assignee: CELERITAS GROUP, LLC, Broomfield, CO (US)

(21) Appl. No.: 15/892,760

(22) Filed: Feb. 9, 2018

Related U.S. Application Data
(62) Division of application No. 14/740,747, filed on Jun. 16, 2015.
(60) Provisional application No. 62/012,514, filed on Jun. 16, 2014.

(51) Int. Cl. G06Q 30/02

(52) U.S. Cl. CPC G06Q 30/0267

(57) ABSTRACT

An interactive marketing system includes devices and methods that provide customers with real-time product information and supplemental specification materials, usage information, comparison information, and other product and service resources related to a product. A potential customer accesses an RFID-tagged item, and a reader detects the item and triggers video and audio displays with information regarding the identified product. Customers interact with the product and service materials to review product information, evaluate product reviews, and view and listen to lifestyle and demonstration videos. Customers can also access product information to configure the product in a variety of sizes, colors, styles, and the like. Brand owners can communicate product information, product reviews, and additional information regarding the product, its features, and its use directly to the customers in real-time. The system facilitates purchasing metrics, tracks and controls inventory, and provides product logistics.

### CROSS-REFERENCE TO RELATED APPLICATION

This application is a divisional application of U.S. patent application Ser. No. 14/740,747, filed on Jun. 16, 2015, which claims priority to U.S. Provisional Application No. 62/012,514. This application claims priority to both previously-filed applications and incorporates the entire contents of both applications herein by reference.

### TECHNICAL FIELD

This technology relates to interactive marketing systems. More specifically, the claimed invention relates to digital product presentation and consumer response systems that provide interactive digital signage within a retail environment.

### BACKGROUND

Advertising and marketing efforts often flow in one direction from marketer to potential consumer. A marketer designs an advertisement, purchases advertising space, publicizes the advertisement, and waits for sales to result. Direct mail, telephone marketing, radio, television, Internet marketing, and other outlets provide marketing materials to consumers. This one way conversation does not create a dialogue about a product but simply provides a message for customers to accept or reject.

In the retail environment, in-store advertisements are commonplace. Signs, posters, and electronic displays provide product details to market and sell to consumers but often provide only a passive display. Digital displays can provide colorful and specific advertisements, but often merely push advertising messages and propaganda to consumers.

The types advertising used to date often falls short in engaging consumers, identifying unmet consumer wants, and satisfying those wants with available products.

### SUMMARY

Retailers and other organizations benefit from understanding details of consumer activity. While some retailers increasingly use digital screens to promote products, these devices do not provide information regarding the interest or activity of the consumer. Brand management teams can use information about customer activity and how people respond to advertising messages on digital screens to increase the effectiveness of their message. Brand management teams benefit from receiving information on customer behavior as it relates to specific products. Data from interactions between products and consumers provide valuable marketing insight, but deploying employees or consultants to observe consumers and take localized surveys is expensive, time-consuming, and often inaccurate and untimely since the collection and the reporting is delayed, and the sample size of the collection is small and influenced both by the interviewer as well as the consumers' willingness to answer the solicitation and direct questioning. Brands and marketers desire to collect this data in real-time based on the activity of the consumers with products within the retail space.

The interactive marketing system of the claimed invention includes devices and methods to provide customers with real-time product information and supplemental specification information, usage information, comparison information, and other merchandising and service information related to a product. A potential customer accesses an RFID-tagged item, and a reader detects the item and triggers video and audio displays with information regarding the identified product. Customers interact with the product and service data to review product information, evaluate product reviews, and view and listen to lifestyle and demonstration videos. Customers can also access product information to configure the product in a variety of sizes, colors, styles, and the like. Brand owners can communicate product information, product reviews, and additional information regarding the product, its features, and its use directly to the customer in real-time. The system facilitates purchasing, tracking and controlling inventory, and providing product logistics.

The invention substantially changes the one-way data monologue within social and interactive environments such as retail spaces, building ingress and egress points, and organized events. The invention collects and processes data to target and deliver meaningful content and information to consumers in real time—establishing a dialogue between consumers and retailers when consumers interact with products.

The invention provides an interactive software and hardware platform which responds to consumer, visitor, guest, or attendant activity with a particular product. The invention provides a method for responding to an activity and collecting multiple data sets, and in turn provides a method to respond to that activity through visual and analytical content.

Using motion technology, augmented reality, multi-touch surfaces, and user mobile devices, the retail experience of the claimed invention extends digital technology and specialized content with web-like interaction. Consumers experience products both tactilely and visually, allowing the customer the ability to physically touch products and actively participate while fully immersed in a presented brand.

One example embodiment of the invention includes a method of providing interactive marketing content to a user by detecting a tagged item with a reader computing device and determining a change in a returned signal of a tag associated with the tagged item. The method converts the determined change in returned signal to actionable activity event data with the reader computing device, accesses a database of digital content based upon the actionable activity event data with a listening computing device, and sends digital content from the database to a display device for consumption by the user. The tag can include an RFID tag, and the reader computing device can include an RFID reader. The actionable activity event data can include a consumer interaction including a change in location, a change in presence, and/or movement from one location to another location. The change in presence can include an enter event, an exit event, and/or a timed event. The digital content can includes a web application, a video, an image, text, a 3D model, an audio message, a map, and/or a camera feed. Likewise, the digital content can include a product demonstration, a product specification, a product configuration, a product review, a product recommendation, an advertisement, a lifestyle demonstration, and/or a coupon.

In one example embodiment of the invention, a method of providing interactive marketing content to a user can also include filtering the actionable activity event data with the listening computing device to further access digital content from the database. Additionally, the method of providing interactive marketing content to a user can include receiving outside data at the listening computing device, and accessing the database of digital content can further include accessing the database of digital content based upon the received outside data. The received outside data can include an identification of the user, an identification of the user's participation in a loyalty program, a SKU number related to a product, an image, a video, an audio message, a time stamp, an inventory control message, and/or a text message.

In one example embodiment of the invention, a method of providing interactive marketing content to a user can also include communicating the actionable activity event data to an additional listening computing device. Additionally, the method can include responding to the received actionable activity event data with the additional listening computing device including accessing a database of digital content and/or updating an inventory attribute.

In an example embodiment of the invention, a method of providing interactive marketing content to a user can include delivering augmented reality content from the database based upon the actionable event data.

In one example embodiment of the invention, a method of providing interactive marketing content to a user can include computing sales analytics based upon the displayed digital content and product sales. Also, a method of providing interactive marketing content to a user can include cataloging the digital content with the actionable activity event data based upon a related variable.

One example embodiment of the claimed invention includes an interactive marketing system for providing content to a user that includes a reader computing device that detects a tagged item, determines a change in a returned signal of a tag associated with the detected tagged item, and converts the determined change in returned signal to actionable activity event data. The system also includes a listening computing device that receives the actionable activity event data and a database accessed by the listening computing device that provides digital content based upon the actionable activity event data. In some example embodiments of the invention, the database is further configured to catalog the digital content with the actionable activity event data based upon a related variable.

The interactive marketing system can also include a display device that displays the digital content from the database for consumption by the user. The tagged item can include an RFID tag, and the reader computing device can include an RFID reader. The listening computing device can further receive outside data, and accessing the database of digital content can include accessing the database of digital content based upon the received outside data.

In one example embodiment of the invention, an interactive marketing system can further include an outside data computing device that sends the outside data to the listening computing device including an identification of the user, an identification of the user's participation in a loyalty program, a SKU number related to a product, an image, a video, an audio message, a time stamp, an inventory control message, and/or a text message. The outside data computing device can include mobile computing devices, UHF devices, HF devices, NFC devices, cameras, gaming consoles, audio devices, and Blue tooth devices.

An additional listening computing device can also be included in an interactive marketing system of the claimed invention to receive the actionable activity event data and respond to the received actionable activity event data by accessing a database of digital content and/or updating an inventory attribute. A sales analytics computing device configured to compute sales and marketing effectiveness measurements based upon the displayed digital content and product sales can also be included in the system.

### BRIEF DESCRIPTION OF THE DRAWINGS

FIG. 1 shows an example interactive marketing system in accordance with the claimed invention on a computer network.

FIG. 2 shows an interactive marketing system and process flow in accordance with the claimed invention.

FIG. 3 shows an example computing device used in the interactive marketing system of the claimed invention.

FIG. 4 shows an abbreviated example flow diagram showing RFID tag detection, decision logic employed by a destination computing device and listening device, and the visible screen activity of a display device.

FIG. 5 shows an example interactive marketing system with multiple input sensors, listening devices, and displays.

FIG. 6 shows a digital content response based on event data collected from a RF loyalty card or handled product with a tag attached.

FIG. 7 shows a locationing event response based on a RF loyalty card or tagged product held by the customer.

FIGS. 8-9 show a digital content response based on event data collected in response to a product being handled by a customer.

### DETAILED DESCRIPTION

Interactive Marketing System

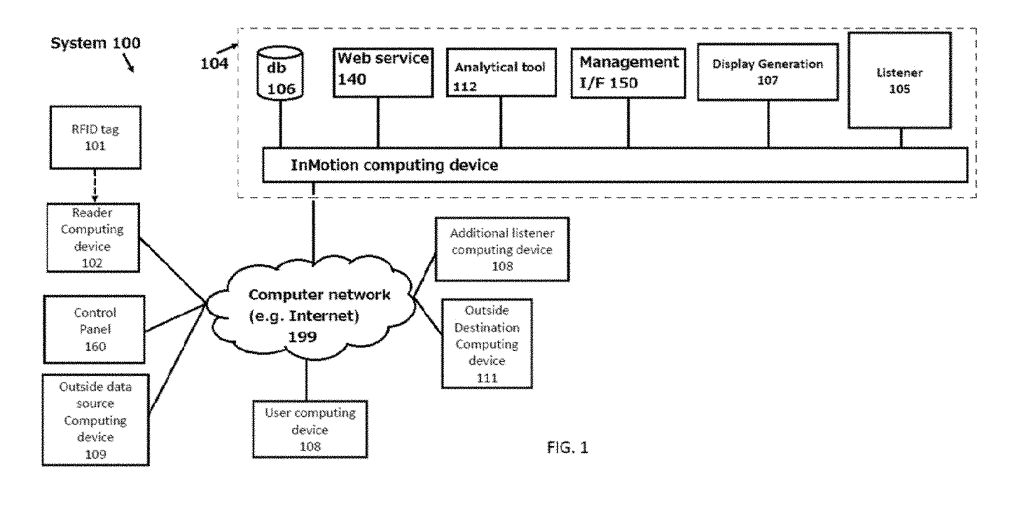

FIG. 1 shows an example interactive marketing system 100 in accordance with the claimed invention on a computer network 199. One example system includes an RFID tag 101, a reader computing device 102, a control panel 160, an outside data source computing device 109, a user computing device 108, an outside destination computing device 111, an additional listener computing device 110, and a destination computing device 104. The control panel provides a user interface for management of reader computer devices 102, settings, and adjustments. The destination computing device 104 can include a database 106, a web interface and service 140, analytical tools 112, a management interface and tools 150, a display generation device and application 107, and a listening device 105.

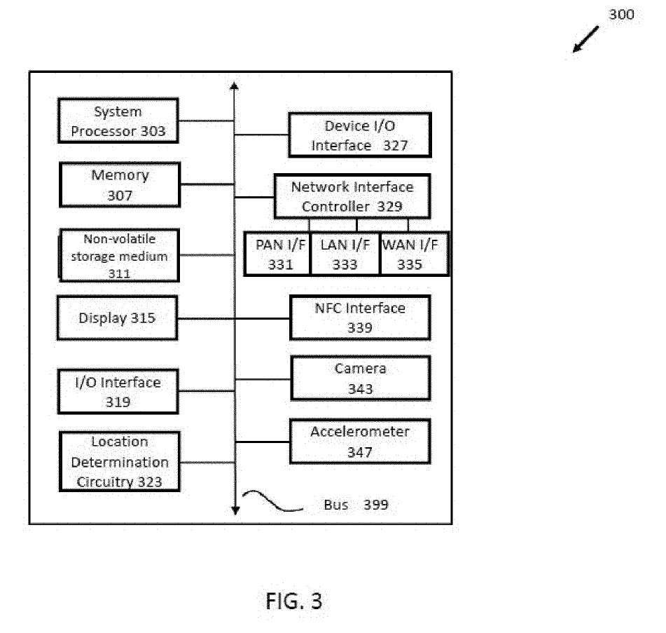

FIG. 3 shows an example computing device 300 and its constituent components used in the interactive marketing system 100 of the claimed invention. Additional details of the components of the example computing device 300 appear below.

Example Environments of Interactive Marketing System

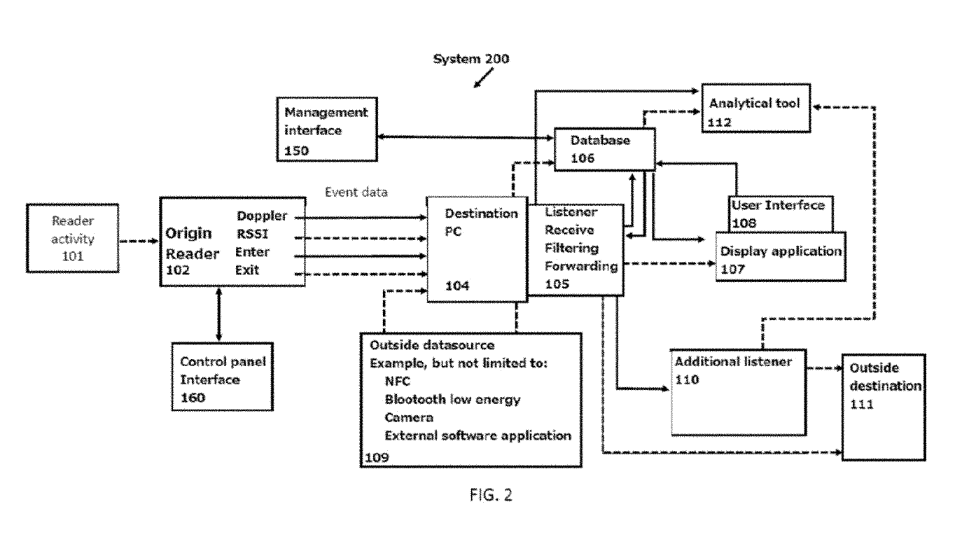

FIG. 2 shows an example system 200 and process flow of the claimed invention. The system 200 senses motion of consumers and delivers visual and audible information to consumers related to activities in which the consumer is participating and products and services that may be of interest to consumers. The system senses and otherwise detects motion of consumers and products using sensors poised to identify an event. One example embodiment of the invention uses radio frequency (RFID) devices or tags to identify multiple levels of consumer interaction in response to the actual motion of products. The RFID devices interact with displays, such as video displays, textual displays, audio displays, and the like, to communicate product brand lifestyle videos, customer reviews, product details and specifications, and specialized content communication. Specialized content communications can include visual and audio content delivered to a display in a store that the user is visiting or to other specified displays, such as a user's phone. For example, a video of a bike path displays on a user's phone when the user picks up a trail map in a store, for example. Specialized content can include any audio, visual, textual, and other types of communication that a display or user's computing device can receive.

An example interactive marketing system of the claimed invention can showcase footwear, apparel, sporting goods, and the like, where a far-field UHF device detects motion of a product, and a video advertisement detailing the features of the product plays on a video monitor next to the product display. Similarly, the system can play brand advertisements and endorsements on a similar video display.

Another example interactive marketing system of the claimed invention can include marketing for cosmetics and electronics products. A near-field UHF device can detect motion of these products, and a monitor or a bank of monitors or other viewers can display content driven by the cosmetics or electronics products. With relatively smaller physical products, localized “read zones” of the sensors provide input to the system, and sellers and marketers can establish multiple read zones with multiple displays to showcase adjacent products.

Another example embodiment of an interactive marketing system of the claimed invention can include a wide area monitoring grid. A single RFID reader can cover a wide area of space (for example, a circular area with a 20 foot radius) and interact directly with consumers in each consumer's particular location and with whatever product the consumer is holding. The system can collect additional metrics regarding the products and locations to identify and understand how products move through retail space during a buying experience. The system can monitor the location of each product item with real time shelf visibility. In addition, the system can identify and visualize movement of products in and out of dressing rooms and other physical zones in a store and provide analytical data regarding tried-on items versus purchased items to supplement inventory, sales, and promotions measures.

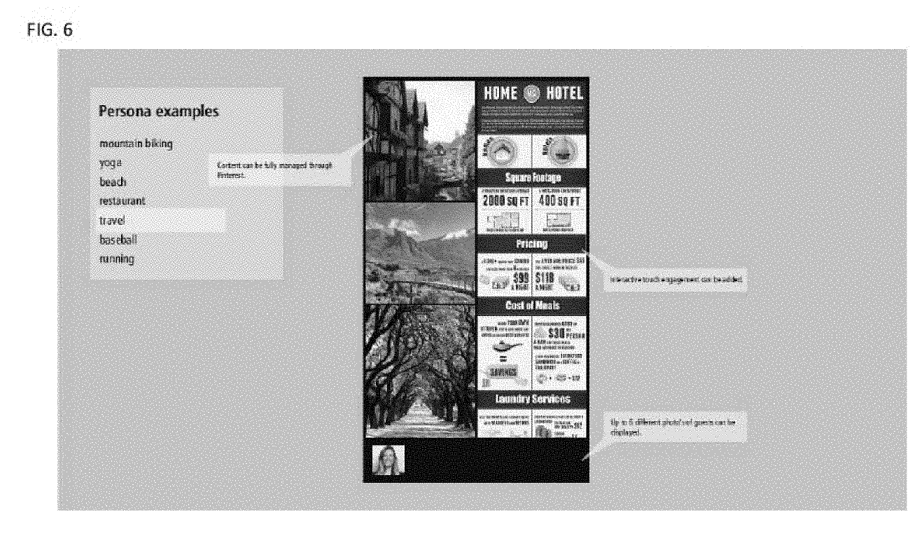

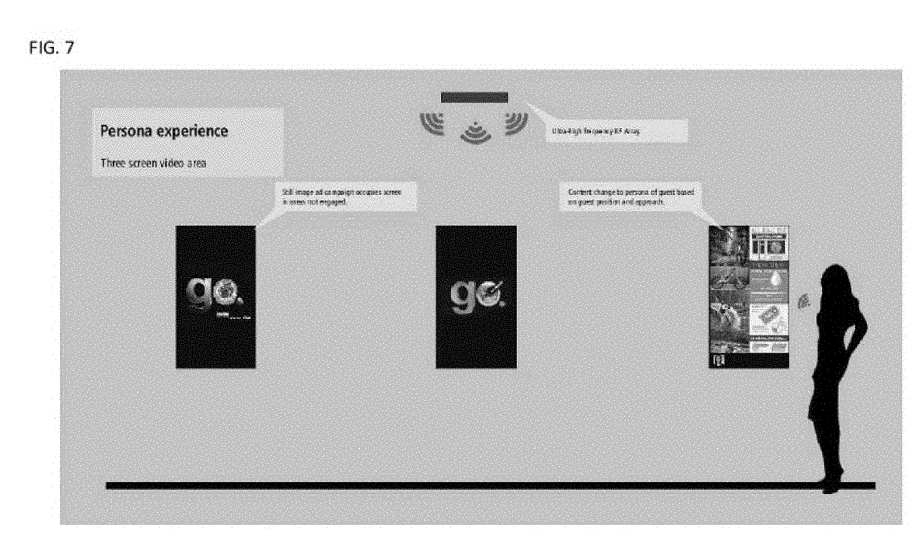

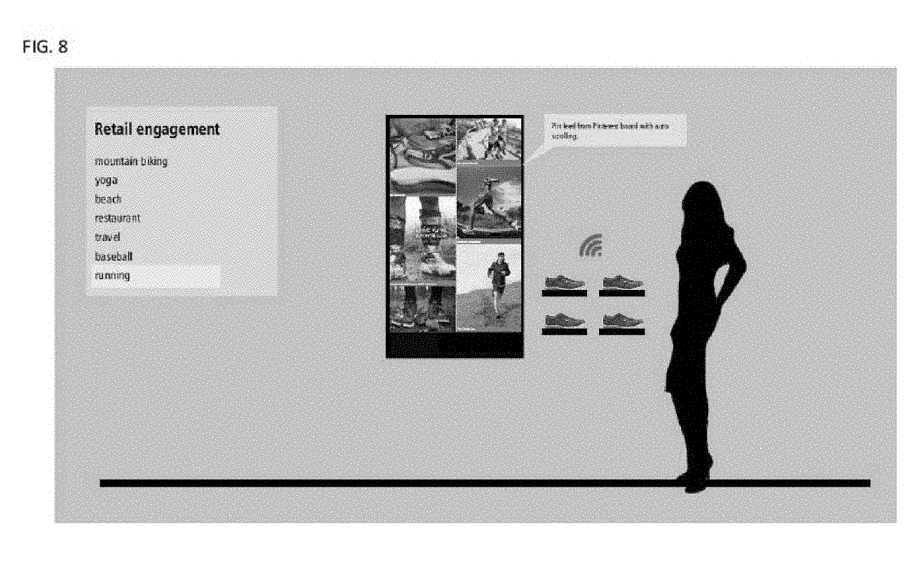

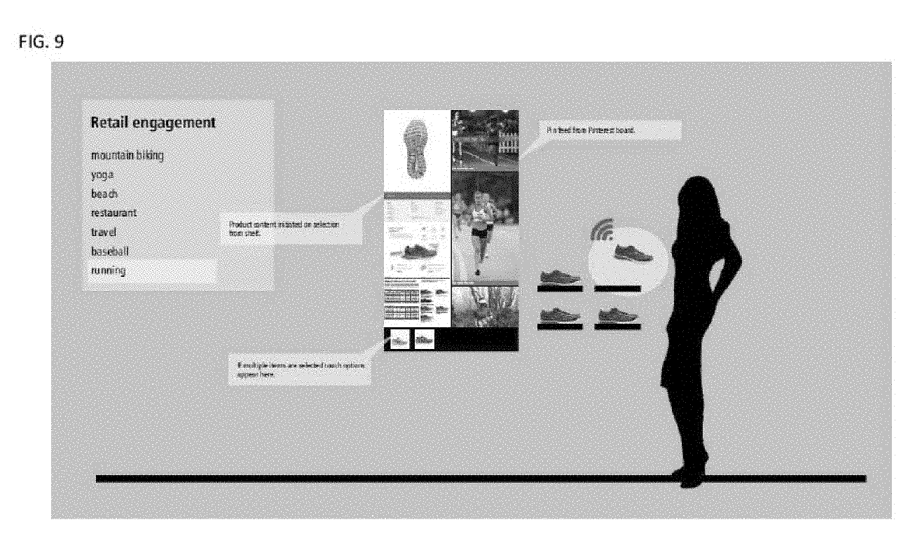

For example, FIG. 6 shows a digital content response demonstrating information displayed relevant to the interests of an individual based on the response to event data collected from a RF loyalty card or a handled product with a tag attached. The digital response provides options to interact and further influence the digital response provided. Additionally, FIG. 7 shows a locationing event response demonstrating the ability of the system to determine the location of the response as well as the content of the response based on a RF loyalty card or tagged product held by the customer. Further, FIGS. 8 and 9 show a digital content response based on event data collected in response to a product being handled by a customer.

In another example embodiment of the interactive marketing system, multi-touch surfaces utilize 40-point capacitive touch technology to engage multiple users and create social interaction while the users interact with products. The system can output displays to an array of different platforms to accommodate the multiple users. Touch tables and video displays provide an interactive environment for the users to collaborate. Mobile computing devices, such as smart phones and tablets, can use near field (NFC) protocols to establish communication between the users and with the touch tables and video displays as the users bring the devices into proximity.

In addition to sensing motion of consumers and delivering visual and audible information to consumers, the interactive marketing system of the claimed invention can provide an augmented reality environment by creating an interactive 3D digital display platform, in combination with RFID, to facilitate consumers' exploration of products that consumers cannot normally physically touch or handle. For example, an augmented reality environment showcases products not in stock or provides a visual depiction of customized products prior to their manufacture. Similarly, augmented reality shows products that are too large or cumbersome to readily (physically) display in a particular retail environment. One example of an augmented reality environment provides a scaled down model of a camping tent on a display shelf in a store. When a consumer picks up the scaled down model of the tent, a reader reads the RFID on the model, and a monitor displays a product video depicting users interacting with an actual size tent. The display shows features and highlights of the actual-size product, gives a video tour of the product, and the like.

Regardless of the form in which the interactive marketing system of the invention is used, the system collects product interaction data and leverages the data for predictive analyses. Marketing personnel, store managers, and floor staff have access to real-time visitor and buying trends and can make inventory, incentives, sales, and marketing adjustments in real-time. Timely reports provide analytics that show consumer activity prior to purchase and promotional effectiveness.

Process Flow of Interactive Marketing System

FIG. 2 shows an example system 200 and process flow of the claimed invention with a variety of computing devices and hardware components. As outlined above, the system 200 senses activities of consumers and delivers visual and audible information to consumers, vendors, and other stakeholders related to activities in which the consumer is participating and related to products and services of interest.

The system 200 detects the status of a sensor with a reader. For example, an RFID reader 102 reads an event of an RFID tag 101. Other events can include a sensor moving from one physical area of a store to another, a sensor remaining in an area for a particular amount of time, users interacting with the sensor, and the like. In the example system 200 shown in FIG. 2, reader activity of RFID tag 101 includes interactions between RF tags and an RFID reader/scanner/computing device, such as RFID reader computing device 102. RFID reading device 102 (“reader 102”) can use Gent or ISO RFID communication standards. The reader 102 includes firmware that identifies event triggers based upon an RFID event. Similarly, the reader 102 can detect a change in status of the RFID tag 101 and forward the change in status to a destination computing device to determine the nature of the event. The system 200 can detect and characterize changes in the presence of the RFID tag 101 as enter events, exit events, timed events, and the like based on Doppler measurements, returned signal strength (RSSI) measurements, as well as an RFID tag 101 entering a particular reader zone (enter event), leaving a particular reader zone (exit event), and the like. In the example embodiment shown in FIG. 2, an Origin application routine embedded within the RFID reader/scanner processes RFID calculations, reader settings, functions, storage, lookup tables, database, and other functions to identify events or activity.

As the reader 102 processes the activity, the firmware/embedded software of the invention identifies certain events by exceeding, by meeting, or by not meeting particular event criteria (e.g., filters). When these events occur, the reader 102 broadcasts the event data. The RFID tag 101 transmits the event data as well as information relevant to the type of event and the environment in which the event occurred. For example, event data can include an RFID tag identifier, RFID reader identifiers, location information, antenna information, Doppler characteristics, RSSI characteristics, the type of event (e.g., enter, exit, etc.), the time of the event, and the like. The event types reflect data filtering constraints and methods. Each antenna, power, event types, and various known reader settings can be adjusted and stored on the reader.

The reader 102 sends event data to a defined destination that is stored in the reader 102. For example, the Origin application routine can store information regarding a destination defined as a network computing device, such as destination computer 104, for example. Destination computer 104 can reside anywhere on the computer network 199, including in the same retail store as the RFID tags 101 and reader 102, in a cloud computing center, in Kentucky, and the like. This network device (destination computer 104) can operate a listener computing device 105 that receives event data. The listening computing device 105 can receive event data on a defined port from the reader 102 and/or from outside data sources 109. Example outside data sources 109 can include mobile computing devices (e.g., smart phones, tablet computers, etc.), other UHF, HF, and NFC (near field communication) devices, photo and video cameras, gaming consoles, audio devices, Blue tooth devices, additional hardware devices and software modules providing additional information that can be used by the listening computing device 105 to choose a response based on the event data and the outside data. One specific example can supplement event data relating to a red handbag that a customer removes from a display shelf. Outside data relating to the SKU of the red handbag can identify a blue sweater that other customers often purchase along with the red handbag. The outside SKU-based data provides an opportunity for the merchant to increase sales by pairing an item in which the customer showed interest with another item in which the customer may be interested.

Another example of outside data source 109 can include a digital camera supplying a time-stamped photo that corresponds to a change in presence, such as an enter event, an exit event, and the like. The photographic information can supplement the event data and provide additional filtering based on the needs at that location. For example, a time stamped photo can show a shoplifter leaving a store as the RFID in the stolen product provides an exit event. An outside source computing device 109 can directly influence filters at the listener device 105 and/or the database 106.

Continuing with the process flow of FIG. 2, the listening computing device 105 communicates with the database 106 both receiving and broadcasting activity and can simultaneously or consecutively broadcast directly to an additional listener computing device 110 or an outside receiver and/or destination computing device 111 prior to communication with the database 106 or with additional data shared from database 106. Additional listening devices 110 can be listening for events from readers in a daisy-chain fashion passing event data from one reader to another, in a parallel manner, passing event data to multiple listening computing devices simultaneously, or in a combination of manners. The different additional listening computing devices 110 can listen to the same event data and respond to it in a variety of different manners. For example, the listening device 105 can respond to event data by delivering a video display (described below) while additional listening device 110 can identify and recognize that a customer removed a product from a bin of similar products and adjust an inventory count of items accordingly. The additional listener 110 can alternatively communicate with yet another listener (not shown separately) or to an outside receiver and/or destination 111.

Similarly, additional listening device 110 can respond to other input from other tags or other outside data sources, such as outside data source 109. For example, outside data source 109 can provide weather information, and the system can display a video directed to rain gear or other foul-weather goods.

The database 106 processes the events received from the listener computing device 105 and communicates actionable activity to the display application 107. The interactive marketing system 200 can use the display device/application 107 as an interactive method of displaying content, web applications, web content (local or other), video, images, text, 3D models, camera feeds, and the like. The display device 107 can incorporate user interactions 108 and communicate activity from the user interactions 108 back to database 106, which in turn influences activity on the display device 107. The database 106 stores event data and data collected based on outside data sources 109, listening computing devices 105, additional listening devices 110, outside destinations 111, and user interactions 108. The database 106 can also catalog the digital content with the actionable activity event data based upon a related variable such as a time-date stamp, a location stamp, a product identifier, a keyword linked to the digital content, indexing identifiers, and other metadata.

The system 200 can provide for analytical tools 112 culled directly from database 106 or from an outside database, also represented by reference numeral 106 in FIG. 2. The analytical tools 112 can collect data from many locations, including, but not limited to, the listener computing device 105, an additional listener device 110, an outside destination 111, and a database 106. The system can display this analytical information on many sources, including display device 107. Database 106 communicates with listener computing device 105 and has influence over the filters in the listener computing device 105. The combined data of both can influence the activity directed to the display device 107 or the additional listener 110 or an outside destination 111.

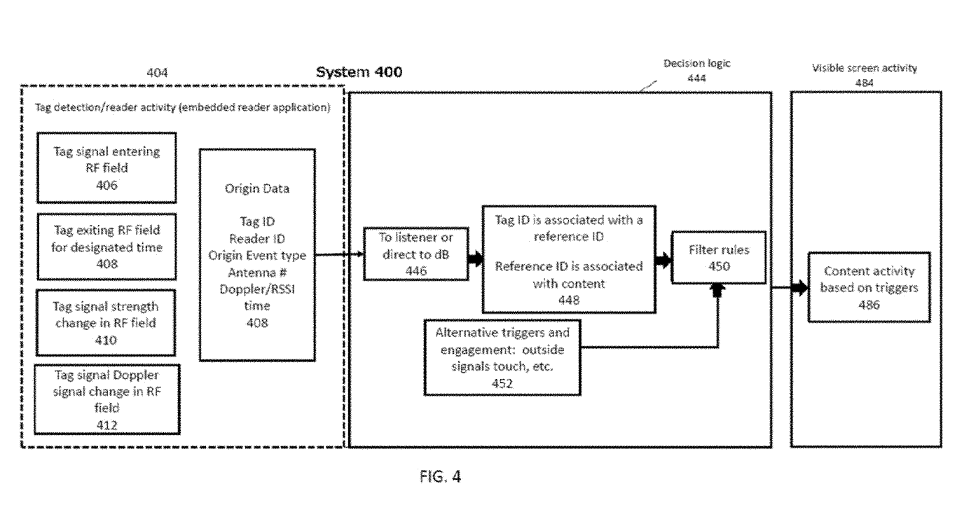

FIG. 4 provides an abbreviated example flow diagram 400 showing activities including RFID tag detection 404, the decision logic 444 employed by the destination computing device 104 and listening device 105, and the visible screen activity 484 of the display device 107. Tag detection/reader activity embedded in the firmware or software application can include a tag signal entering an RFID detection (reader) field 406, a tag signal exiting an RFID detection (reader) field 408, a tag signal strength changing in an RFID detection (reader) field 410, such as that detected by an RSSI, a tag signal Doppler signal change in RF field 412, and the like to provide and determine event types.

As outlined above, event data can also include an RFID tag identifier, RFID reader identifiers, location information, antenna information, Doppler characteristics, RSSI characteristics, the type of event (e.g., enter, exit, etc.), the time of the event, and the like.

The tag detection/reader activity 404 passes along to a listener computing device 105 on a destination computing device 104 in block 446, and the identification information 448 is used to apply the filter rules in block 450. Alternative triggers and outside data sources 109 from block 452 can also influence the filter rules 450.

As the alternative triggers and outside data sources 109 from block 452 conflate with filter rules 450, the system 400 determines visible screen activity 484. That is, content activity 486 based on the singular or plurality of events, triggers, and rules displays on display device 107. In the example shown in FIG. 4, an exit tag event coupled with RFID reader B using antenna #2 results in content F displayed on display device #4.

Alternative System Configurations

In addition to the example processes outlined above, the interactive marketing system can carry out alternative steps and processes and methods. For example, the origin application (e.g., RFID reader 102) can send event data directly to the database 106 and/or to the analytical tool computing device 112. Additionally, outside data source 109 can control the filters in the listening device 105 and in the database 106. Further, the listener 105 can broadcast and/or communicate directly with the multiple database locations and can communicate directly with the display device 107. The system 200 in the above examples described a listening device 105 as separate from the origin application (e.g., RFID reader 102) but can also be integrated into a single physical device. Likewise, outside destination 111 can be the same as an outside data source 109. Also, while a single display device 107 can receive the determined content, the listening device 105 can communicate with multiple display applications, providing the same determined content to all the displays or different content to each display, or a combination of content to a combination of display devices.

Example Interactive Marketing System with Multiple Inputs and Outputs

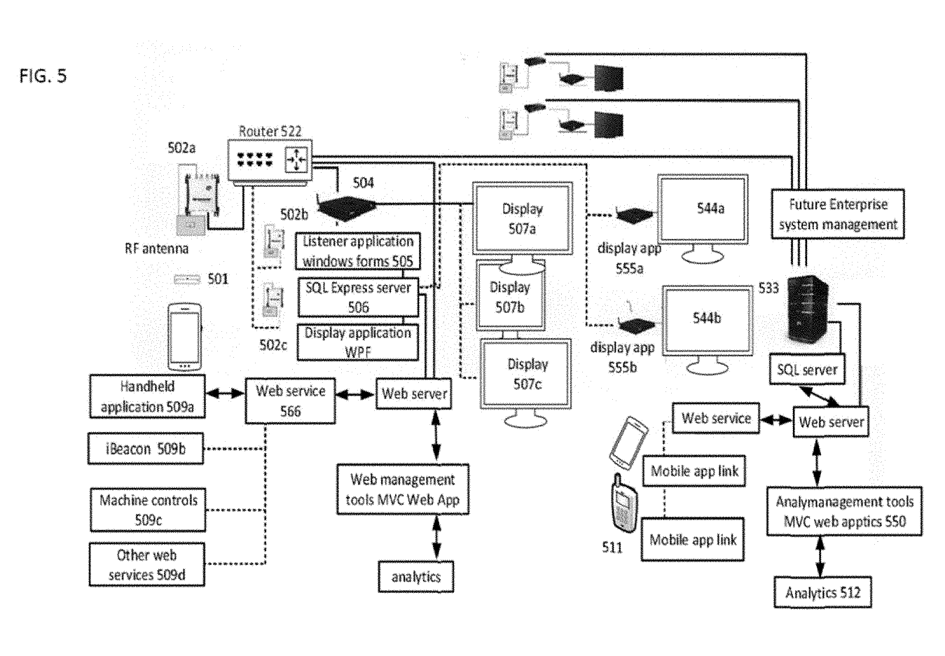

As shown in FIG. 5, the interactive marketing system of the claimed invention can be scaled to larger or smaller configurations based on the environment in which it is used. For example, multiple RFID readers 502a, 502b, 502c can read RFID tags, such as RFID tag 501. A router 522 can be used to forward data from the readers 502a, 502b, and 502c to a number of networks, including networks with destination computing device 504 with listening device 505 capabilities and remote servers 533. The destination computing device 504/listening device 505 can access database 506 and provide content to display devices 507a, 507b, and 507c as well as additional listener computing devices 555a, 555b and displays 544a, 544b.

Outside data sources 509a, 509b, 509c, 509d can include handheld devices, Bluetooth low energy devices that broadcast identifiers to other portable electronics devices (e.g., iBeacon devices), machine and control panel controls, and other web services. The outside data sources 509a, 509b, 509c, 509d can utilize a web service 566 to access listening computing device 505 via web servers and network applications. Likewise, outside destinations 511 can also access listening devices to construct rules to also determine the content displayed.

Regardless of the simplicity or complexity of the interactive marketing system, sensed events subjected to constraints determine content displayed.

Interactive Marketing System Computing Device Components:

As shown in FIG. 3, the interactive marketing system of the claimed invention employs a number of integrated and/or discrete computing devices 300. The computing devices 300 include system processor(s) 303, system memory 307, system I/O interface(s) 319, network interface controller 329, location determining circuitry 323, and a display 315, which are coupled together by a bus 399 or other types of links. Additionally, the computing devices 300 also can include nonvolatile storage medium 311, device I/O interface 319, camera 343, and accelerometer 347. The interactive marketing system computing devices can include other components and elements in other configurations. In one example, some of the computing devices are implemented as standalone handheld electronic devices.

The computing devices can be configured for interacting with the interactive marketing system described above. As discussed below with reference to FIGS. 1-5, the computing devices may be, among other things, a handheld device, a computer, or a media player adapted to obtain, store, or use product information, usage information, specifications, and other events or activities using methods described throughout this disclosure. The computing device(s) can be an iPhone®, iPod®, iMac®, MacBook, available from Apple Inc., as well as any number of devices available from Nokia, RIM, Motorola, HTC, Samsung, LG, HP, or similar devices such as by any manufacturer. In other example embodiments of the claimed invention, the computing device can include more or fewer elements than those shown in FIG. 3.

As illustrated in FIG. 3, the computing devices 300 include at least one system processor 303. For example, the system processor 303 can include one or more microprocessors, and the microprocessors may be “general purpose” microprocessors, a combination of general and special purpose microprocessors, or application specific integrated circuits (ASICS). Additionally or alternatively, the system processor 303 can include one or more reduced instruction set (RISC) processors, video processors, or related chip sets. The system processor 303 can additionally or alternatively include programmable logic devices (PLDs), field programmable logic devices (FPLDs), field programmable gate arrays (FPGAs), and the like, programmed or configured according to the teachings as described and illustrated with respect to FIGS. 1-5. The system processor 303 can provide processing capability to execute an operating system, run various applications, execute machine readable and executable instructions stored in system memory, and/or provide processing for one or more of the techniques described in this disclosure. Some example applications that can run on the computing device 300 include a music player, a video player, a picture displayer, a calendar, an address book, an email client, a telephone dialer, and the like. In addition, software for providing functionality to the interactive marketing system can be included on the computing device 300.

A system memory 307 is coupled and communicates with the system processor 303 via a bus 399. The system memory 307 can store data and executable code. The system memory 307 can represent volatile memory such as RAM, but can also include nonvolatile memory, such as read-only memory (ROM) or Flash memory. System memory 307 can also include removable and non-removable media implemented in any method or technology for storage of information, such as computer readable/machine-executable instructions, data structures, program modules, or other data, which can be obtained and/or executed by one or more processors, such as system processor 303, to perform actions, including implementing an operating system for controlling the interactive marketing system computing devices to review, evaluate, and purchase goods and services in accordance with the processes described above in connection with FIGS. 1-5, for example. In buffering or caching data related to operations of the system processor, the system memory 307 can store data associated with open applications running on the computing device.

The computing device can also include a nonvolatile storage medium 311. The nonvolatile storage medium 311 can represent any suitable nonvolatile storage medium, such as a hard disk drive or nonvolatile memory, such as flash memory. Other examples of nonvolatile storage medium include RAM, BIOS, ROM, EEPROM, flash/firmware memory, CD-ROM, digital versatile disks (DVD) or other optical storage, magnetic cassettes, magnetic tape, magnetic disk storage or other magnetic storage devices, or any other nonvolatile storage medium that can be used to store the desired information. The nonvolatile storage medium 311 is well-suited to long-term storage and can store data files such as media (e.g., music files, video files, pictures, and the like), software (e.g., for implementing functions on the computing device), preference information (e.g., media playback preferences, desktop background image, ringtones, etc.), transaction information (e.g., credit card data, records of transactions, etc.), wireless connection information (e.g., wireless network names and/or passwords, cellular network connections, etc.), subscription information (e.g., a record of podcasts, television shows, or other media to which a user subscribes), as well as personal information (e.g., contacts, calendars, email, etc.). Additionally, module and unit data can be saved in the nonvolatile storage medium, as discussed further below.

In some example embodiments, a display 315 that is part of the computing device can display images and/or data. The display 315 can be any suitable display, such as a liquid crystal display (LCD), a plasma display, an electronic paper display (e.g., E Ink), a light emitting diode (LED) display, an organic light emitting diode (OLED) display, a cathode ray tube (CRT) display, or an analog or digital television. In some example embodiments, the display 315 can include touch screen or multi-touch screen technology through which a user can interface with the computing device.

The computing device 300 can also have a system I/O interface 319. The system I/O interface 319 can include, for example, indicator lights, user inputs, and/or a graphical user interface (GUI) on the display. In practice, the system I/O interface 319 can operate via the system processor, using memory from the system memory 307 and long-term storage in the nonvolatile storage medium. In an embodiment without a display, indicator lights, sound devices, buttons, and other numerous input/output (I/O) devices can allow a user to interface with the computing device 300. In an embodiment with a GUI, the system I/O interface 319 can provide interaction with interface elements on the display via certain user input structures, user input peripherals such as a keyboard or mouse, or a touch sensitive implementation of the display. The system I/O interface 319 enables the interactive marketing system computing devices 300 to communicate with the outside environment for accepting user data input and to provide user output.

In operation of the computing device 300, one or more applications can be open and accessible to a user via the system I/O interface 319 and/or displayed on the display 315 of the computing device. The applications can run on the system processor in conjunction with the system memory 307, the nonvolatile storage medium 311, the display 315, and the system I/O interface 319. Various data can be associated with each open application. As discussed in greater detail above, instructions stored in the system memory 307, the nonvolatile storage medium, or the system processor of the computing device can obtain, store, and transfer user interactions. Users can employ the computing device 300 to manage the interactive marketing processes. The instructions for carrying out such processes can embody a standalone application, a function of the operating system of the computing device, or a function of the hardware of the system processor, the system memory 307, the nonvolatile storage medium 311, or other hardware of the computing device 300.

In some embodiments of the claimed invention, the computing device 300 can include location determination (determining) circuitry 323. The location determining circuitry can include RFID circuitry and global positioning system (GPS) circuitry, but can also represent one or more algorithms and databases, stored in the nonvolatile storage medium 311 or system memory 307 and executed by the system processor 303 that can be used to infer location based on various observed factors. For example, the location determining circuitry can include an algorithm and database that approximates geographic location based on the detection of local wireless networks (e.g., 802.11x, otherwise known as Wi-Fi) or nearby cellular phone towers. As discussed in this disclosure, the computing device 300 can employ the location determining circuitry as a factor for carrying out certain interactive marketing processes in accordance with the application of the claimed invention. For example, the computing device can use location determining circuitry to determine a user's location during an event. The location during the event can then affect and/or determine the interactive marketing process provided to/from the computing device. The location information enables the computing devices to output personalized data or to display data in response to a user's location and activities.

The computing device can also include a device input/output (I/O) interface 327 for a wired interconnection between one computing device and another computing device. The wired device I/O interface 327 can be, for example, a universal serial bus (USB) port or an IEEE 1394 port (e.g., FireWire®, available from Apple Inc.), but can also represent a proprietary connection. Additionally, the wired device I/O interface 327 can permit a connection to peripheral user interface devices, such as a keyboard or a mouse.

Network interface controllers 329 can provide physical access to networking media and provides a low-level addressing system, which enables the interactive marketing computing devices 300 to engage in TCP/IP communications and other communications with other devices over the computer network 199 (shown in FIG. 1). One or more network interface controllers 329 can provide additional connectivity for the computing device 300. The network interface controllers 329 can include, for example, one or more network interface cards (NIC), transceivers, transceiving devices, or network controllers that transmit and receive network data packets over one or more networks. In some embodiments, the network interface controller 329 can include a personal area network (PAN) interface 331. The PAN interface 331 may provide capabilities to network with, for example, a Bluetooth® network, an IEEE 802.15.4 (e.g., ZigBee) network, or an ultra wideband (UWB) network. The networks accessed by the PAN interface 331 can, but do not necessarily, represent low power, low bandwidth, or close range wireless connections. The PAN interface 331 can permit one computing device 300 to connect to another local computing device via an ad-hoc or peer-to-peer connection. However, the connection can be disrupted if the separation between the two electronic devices or badge exceeds the range of the PAN interface 331.

The network interface controller 329 can also include a local area network (LAN) interface 333. The LAN interface 333 can be, for example, an interface to a wired Ethernet-based network or an interface to a wireless LAN, such as a Wi-Fi network. The range of the LAN interface 333 can generally exceed the range available using the PAN interface 331. Additionally, in many cases, a connection between two electronic computing devices via the LAN interface 333 can involve communication through a network router or other intermediary device.

Additionally, for some example embodiments of the computing device 300, the network interface controllers 329 can include the capability to connect directly to a wide area network (WAN) via a WAN interface 335. The WAN interface 335 can permit a connection to a cellular data network, such as the Enhanced Data rates for GSM Evolution (EDGE) network, a 3G network, or another cellular network. When connected via the WAN interface 335, the computing device 300 can remain connected to the Internet and, in some example embodiments, to another computing device, despite changes in location that might otherwise disrupt connectivity via the PAN interface 331 or the LAN interface 333. The wired device I/O interface 327 and the network interface controllers 329, 331, 333, 335 can represent high-bandwidth communication channels for transferring user data using the simplified data transfer techniques discussed herein.

Some example embodiments of the computing devices 300 can also include a near field communication (NFC) interface 339. The NFC interface 339 can allow for extremely close range communication at relatively low data rates (e.g., 424 kb/s), and can comply with such standards as ISO/IEC 18092, ECMA-340, ISO/IEC 21481, ECMA-352, ISO 14443, and/or ISO 15693. The NFC interface can have a range of approximately 2-4 cm. The close range communication with the NFC interface 339 can take place via magnetic field induction, allowing the NFC interface 339 to communicate with other NFC interfaces or to retrieve information from tags having radio frequency identification (RFID) circuitry and with other NFC-equipped computing devices. The NFC interface 339 can enable initiation and/or facilitation of data transfer of documents and other data from one computing device to another computing device as shown in FIGS. 1-5.

The computing devices 300 can also include a camera 343 or other outside data sources. With the camera 343, the computing device 300 can obtain digital images and/or videos. For example, interactive marketing processes and documents can be obtained for conversion using the camera 343. In combination with optical character recognition (OCR) software, barcode-reading software, or QR-code-reading software running on the computing device 300, the camera 343 can be used to input data from printed materials having text or barcode information into an application/method of the claimed invention.

In addition, in some example embodiments of the computing devices, one or more accelerometers 347 can be included that sense the movement and/or orientation of the computing device 300. The accelerometers 347 can provide input or feedback regarding the position of the computing device 300 to the interactive marketing process application (and others) running on the system processor 303. The accelerometer information enables the applications to output and/or display personalized data or to output and/or display data in an innovative manner in response to a user's movement. The accelerometers 347 can include a 3-axis accelerometer from InvenSense, ST Microelectronics, or Analog Devices, for example.

The bus 399 includes at least one internal device component communication bus, link, bridge, and supporting components, such as bus controllers and/or arbiters. These devices enable the various components of the interactive marketing computing devices 300, such as the display 315, system processor 303, system memory 307, system I/O interface 319, network interface controller 329, and location determining circuitry 323 (as well as wired device I/O interface 327, camera 343, accelerometer 347, and nonvolatile storage medium 311) to communicate, although the bus 399 can enable one or more components of the interactive marketing computing device 300 to communicate with components in other devices as well. By way of example only, example buses include HyperTransport, PCI, PCI Express, InfiniBand, USB, Firewire, Serial ATA (SATA), SCSI, IDE and AGP buses, although other types and numbers of buses can be used, and the particular types and arrangement of buses will depend on the particular configuration of the interactive marketing system computing device 300.

In addition to touch-sensitive input capabilities of the display 315, user input switches can augment and/or replace the touch-sensitive input capability of the display for interaction with the system I/O interface 319. The switches can include buttons, switches, a control pad, keys, knobs, a scroll wheel, or any other suitable input structures. The user input switches can work in conjunction with the display to control functions of the computing device. The user input switches can include an on/off switch, a navigation button for navigating the system I/O interface to a home screen, buttons for controlling volume, buttons for navigating up and down display screen, a mute switch, a lock slide, and the like.

The computing device 300 can also include audio input and/or output buttons. The audio buttons can include a microphone(s) that receives a user's voice data and/or a speaker(s) that output audio data from the computing device. The output audio can include ring tones, songs, video sound tracks, telephone call audio data, recorded audio input data stored on the computing device, the badge, or elsewhere. An audio input connector can also be included on the computing device to allow external audio inputs (e.g., from microphones and other audio output devices) and to allow external audio outputs (e.g., to headphones, ear buds, speakers, and other audio input devices).

While each of the computing devices and servers can include the above constituent components coupled together by a bus, two or more computing devices and/or servers can be substituted for any one of the user devices or server(s) in the system. Likewise, other numbers and types of each of the components and other configurations and locations for the components can be used. Accordingly, principles and advantages of distributed processing, such as redundancy, replication, and the like, also can be implemented as desired to increase the robustness and performance of the user devices and server(s) of the system. The system can also be implemented on a computer system or systems that extend across any network environment using any suitable interface mechanisms and communications technologies including, for example telecommunications in any suitable form (e.g., voice, modem, and the like), Public Switched Telephone Network (PSTNs), Packet Data Networks (PDNs), the Internet, intranets, a combination thereof, and the like.

The processors 303 in the computing devices 300 can execute a program of stored instructions for one or more aspects of the methods and systems as described in this disclosure, although the processor 303 could execute other types of programmed instructions. The memory 307 can store these programmed instructions for one or more aspects of the methods and systems as described in this disclosure, although some or all of the programmed instructions could be stored and/or executed elsewhere.

The operation of example processes to provide a system and method of interacting with an interactive marketing system and application shown in FIGS. 1-5 can be run on the interactive marketing server (computing device 104). The flow diagrams in this disclosure are representative of example machine readable instructions executed by the computing device(s) and/or server(s) for implementing the process of interacting with an interactive marketing system, program, and application. The steps described above are example machine readable instructions for implementing a method in accordance with the examples described in this disclosure. In one example, the machine readable instructions include an algorithm for execution by: (a) a processor, (b) a controller, and/or (c) one or more other suitable processing device(s). The algorithm can be instantiated in software stored on tangible media such as, for example, the system memory 307 and/or nonvolatile storage medium, but persons of ordinary skill in the art will readily appreciate that the entire algorithm and/or parts thereof could alternatively be executed by a device other than a processor and/or embodied in firmware or in dedicated hardware including application specific integrated circuits (ASIC), programmable logic devices (PLD), field programmable logic devices (FPLD), field programmable gate arrays (FPGA), and the like). For example, any or all of the components of the interactive marketing system could be implemented by software, hardware, and/or firmware.

The claimed invention is:

1. A computer-implemented method of reducing network traffic when tracking an item tagged with an RFID tag, the method comprising:
detecting a returned signal value of the RFID tag associated with the tagged item with a reader computing device;
comparing the detected returned signal value of the RFID tag associated with the tagged item to an event criterion;
determining an event based upon the comparison of the detected returned signal value of the RFID tag associated with the tagged item;
sending the determined event to a listening computing device over a computer network;
receiving subsequent returned signals of the RFID tag associated with the tagged item;
comparing the subsequent received returned signals of the tagged item to an additional event criterion;
determining a change in signal value of the subsequent returned signal of the RFID tag associated with the tagged item;
suppressing transmission to the listening computing device over the computer network of the subsequent received returned signals of the tagged item that do not include a change in the subsequent returned signal of the RFID tag associated with the tagged item;
converting the determined change in the subsequent returned signal value of the RFD tag to an actionable event with the reader computing device; and
sending the determined actionable event to the listening computing device over a computer network.

2. A computer-implemented method of reducing network traffic when tracking an item tagged with an RFID tag of claim 1, further comprising:
accessing a database of digital content based upon the actionable event with the listening computing device; and
sending the digital content from the database to a display device.

3. A computer-implemented method of reducing network traffic when tracking an item tagged with an RFID tag of claim 1, wherein the actionable event includes at least one of a change in location, a change in presence, and movement of the item from one location to another location.

4. A computer-implemented method of reducing network traffic when tracking an item tagged with an RFID tag of claim 1, wherein the actionable event is a change in presence that includes at least one of an enter event, an exit event, and a timed event.

5. A computer-implemented method of reducing network traffic when tracking an item tagged with an RFID tag of claim 2, wherein the digital content includes at least one of a web application, a video, an image, text, a 3D model, an audio message, a map, and a camera feed.

6. A computer-implemented method of reducing network traffic when tracking an item tagged with an RFID tag of claim 2, wherein the digital content includes at least one of a product demonstration, a product specification, a product configuration, a product review, a product recommendation, an advertisement, a lifestyle demonstration, and a coupon.

7. A computer-implemented method of reducing network traffic when tracking an item tagged with an RFID tag of claim 2 further comprising:
filtering the actionable event with the listening computing device to further access digital content from the database.

8. A computer-implemented method of reducing network traffic when tracking an item tagged with an RFID tag of claim 2 further comprising:
receiving outside data at the listening computing device, and wherein accessing the database of digital content further includes accessing the database of digital content based upon the received outside data.

9. A computer-implemented method of reducing network traffic when tracking an item tagged with an RFID tag of claim 8, wherein the received outside data includes at least one of an identification of the user, an identification of the user's participation in a loyalty program, a SKU number related to a product, an image, a video, an audio message, a time stamp, an inventory control message, and a text message.

10. A computer-implemented method of reducing network traffic when tracking an item tagged with an RFID tag of claim 1 further comprising:
communicating the actionable event to an additional listening computing device.

11. A computer-implemented method of reducing network traffic when tracking an item tagged with an RFID tag of claim 10 further comprising:
responding to the received actionable event with the additional listening computing device including at least one of accessing the database of digital content and updating an inventory attribute.

12. A computer-implemented method of reducing network traffic when tracking an item tagged with an RFID tag of claim 2 further comprising:
delivering augmented reality content from the database based upon the actionable event.

13. A computer-implemented method of reducing network traffic when tracking an item tagged with an RFID tag of claim 2 further comprising:
computing sales analytics based upon the displayed digital content and product sales.

14. A computer-implemented method of reducing network traffic when tracking an item tagged with an RFID tag of claim 1 further comprising:
cataloging the digital content with the actionable event based upon a related variable.

15. A computer system for reducing network traffic when tracking an item tagged with an RFID tag comprising:
a reader computing device that detects a returned signal value of the RFID tag associated with the tagged item, compares the detected returned signal value of the RFID tag associated with the tagged item to an event criterion, and determines an event based upon the comparison of the detected returned signal value of the RFID tag associated with the detected tagged item,
sends the determined event to a listening computing device over a computer network;
receives subsequent returned signals of the RFID tag associated with the tagged item;
compares the subsequent received returned signals of the tagged item to an actionable event criterion;
determines a change in the subsequent returned signal of the RFID tag associated with the tagged item;
suppresses transmission to the listening computing device over the computer network of the subsequent received returned signals of the tagged item that do not include a change in the subsequent returned signal of the RFID tag associated with the tagged item;
converts the determined change in subsequent returned signal value of the RFD tag to an actionable event; and
sends the determined actionable event to a listening computing device over the computer network.

16. A computer system of claim 15 further comprising:
a listening computing device that receives the actionable event from the reader computing device; and
a database accessed by the listening computing device that provides digital content based upon the actionable event.

17. A computer system of claim 16 further comprising:
a display device that displays digital content from the database.

18. A computer system of claim 16, wherein the listening computing device receives outside data, and wherein accessing the database of digital content further includes accessing the database of digital content based upon the received outside data.

19. A computer system of claim 18 further comprising:
an outside data computing device that sends the outside data to the listening computing device including at least one of an identification of a user, an identification of the user's participation in a loyalty program, a SKU number related to a product, an image, a video, an audio message, a time stamp, an inventory control message, and a text message.

20. A computer system of claim 19, wherein the outside data computing device includes at least one of a mobile computing devices, a UHF device, an HF device, an NFC device, a camera, a gaming console, an audio device, and a Blue tooth device.

21. A computer system of claim 15 further comprising:
an additional listening computing device that receives the actionable event and responds to the received actionable event by at least one of accessing the database of digital content and updating an inventory attribute.

22. A computer system of claim 16 further comprising:
a sales analytics computing device that computes sales and marketing effectiveness measurements based upon the displayed digital content and product sales.

23. A computer system of claim 16, wherein the database catalogs the digital content with the actionable event based upon a related variable.

24. A computer-implemented method of reducing network traffic when tracking an item tagged with an RFID tag of claim 1, wherein the reader computing device includes a plurality of antennae, and wherein the reader computer device eliminates multiple reporting of the determined event by sending a single determined event to the listening device.

25. A computer-implemented method of reducing network traffic when tracking an item tagged with an RFID tag of claim 1, wherein the returned signal value of the RFID tag associated with the tagged item is at least one of a Doppler measurement and a returned signal strength (RSSI) measurement.

26. A computer-implemented method of reducing network traffic when tracking an item tagged with an RFID tag of claim 1 further comprising:
storing the determined change in returned signal value to memory storage device; and
calculating a last known location position based on the stored determined change in returned signal value.
